(19) United States
(12) Patent Application Publication
(10) Pub. No.: US 2012/0259920 A1
(43) Pub. Date: Oct. 11, 2012

(54) PEER-TO-PEER COMMUNICATION ACCORDING TO TRANSMISSION CAPACITY

(75) Inventors: Bertrand Mathieu, Pleumeur Bodou (FR); Pierre Paris, Lannion (FR); Jean-François Peltier, Ploumilliau (FR)

(73) Assignee: France Telecom, Paris (FR)

(21) Appl. No.: 13/518,022

(22) PCT Filed: Dec. 20, 2010
(86) PCT No.: PCT/FR2010/052819

§ 371 Date: Jun. 21, 2012

(30) Foreign Application Priority Data
Dec. 22, 2009 (FR) 0959421

(51) Int. Cl. G06F 15/16

(52) U.S. Cl. 709/204

(57) ABSTRACT

In a peer-to-peer communication network between terminals, classes are assigned respectively to said terminals, a class indicating the transmission capacity of the terminal. The transmission capacity of a terminal corresponds to at least one transmission characteristic associated with the terminal and depends at least on a type of underlying physical network to which the terminal belongs. At a first terminal, a request is received to transmit digital content to a second terminal, the request indicating the class assigned to the second terminal. Then a decision is made whether or not to transmit a least a portion of the digital content to the second terminal, on the basis of said indicated class. Finally, the decision is transmitted to the second terminal.

The invention relates to the field of transmissions within networks, particularly peer-to-peer networks which are also known as P2P networks.

A peer-to-peer network is based on a technology of direct data exchanges between computers or peers which are connected to each other via the transmission resources of a physical communication network or networks. Such a P2P network allows direct communication between multiple computers without passing through a central server.

More specifically, P2P networks use the transmission resources of the underlying physical communication networks. The transmissions sent over P2P communication networks may therefore impact the underlying physical network or networks corresponding to the transmission resources used.

In a P2P network, the peers communicate and share resources such as computational power, digital content, or elements of information.

In general, P2P communications are based on communication principles that give preference in the exchanges to peers that have already contributed to the P2P network, particularly by exchanging a large amount of data. More specifically, a contacted peer can decide whether to transmit requested digital content based on the amount of P2P data already received from the peer requesting this content. In this context, peers in the P2P network that are active in providing digital content are given preference in receiving other digital content, while peers which transmit relatively little data are have low priority for receiving digital content.

In this type of P2P network, the peers which provide little content are at a disadvantage. By adopting this approach, the peers which are very active in the P2P data transmission are given preference in receiving requested digital content over the peers which have decided not to share their digital content. This is to avoid “free riders”, the peers which want to take advantage of the P2P network and receive digital content without providing their own digital content in exchange.

However, under certain conditions, these communication principles penalize certain peers in an unfortunate manner.

The invention aims to improve this situation.

A first aspect of the invention proposes a peer-to-peer communication method between terminals,

wherein classes are respectively assigned to said terminals, each class indicating a transmission capacity of the terminal;
said method comprising the following steps in a first terminal:
/1/ receiving a request to transmit digital content to a second terminal, said request indicating the class assigned to the second terminal;
/2/ deciding whether or not to transmit at least a portion of said digital content to said second terminal on the basis of said indicated class; and

/3/ transmitting the decision to the second terminal.

More specifically, the transmission capacity of a terminal corresponds to at least one transmission characteristic associated with the terminal and depends at least on a type of underlying physical network to which the terminal belongs.

In this context, terminals can exchange data directly, peer to peer. A terminal that wants to receive digital content can directly request it from one or more other terminals. Each of these terminals may then decide to respond to this request by sending all or part of the digital content requested, or may decide to refuse the requested transmission. It is advantageous here to assign a class to each terminal of this P2P communication network in order to associate it with a transmission capacity.

“Terminal” is understood to mean any type of terminal able to send and/or receive a stream of data corresponding to the transmission of digital content. Such a terminal may be a computer, a cell phone, etc.

“Transmission capacity” is understood to mean a value which indicates the capacity of a terminal for transmitting data, meaning the characteristics of this terminal concerning the data throughput it is able to provide. The transmission capacity of a terminal may depend on various parameters. No limitation is placed on the type of parameters which may be taken into account to determine such a value.

By taking into consideration the transmission characteristics associated with each terminal, it is possible to weight the decisions on whether to accept or reject the transmission of digital content.

The invention can be applied to a P2P communication protocol that is based on giving preference to digital content requests issuing from terminals which have greatly contributed to P2P exchanges, over requests from those which have low contributions to the P2P network. In this case, it is advantageous to weight their behavior by also taking into account the fact that certain terminals send little data over the P2P network because their transmission capacity is limited.

This type of weighting is advantageous, particularly when disparities in the transmission capacity of the different terminals exist within the P2P network concerned.

Taking into account this transmission capacity assigned to or associated with each terminal advantageously allows distinguishing the terminals which could transmit more but “voluntarily” choose not to do so, from those which transmit little because they do not have the capacity. By taking this transmission capacity into account for each terminal, it is possible to treat them differently in some cases, for example depending on the applications used in the P2P network concerned.

In this way it is easy to give preference to the transmission of digital content to a terminal which has a low transmission capacity compared to a terminal which has a high transmission capacity, in the case where the two terminals have furnished about the same amounts of data via P2P in the past. This would consist of giving priority to terminals which have a limited transmission capacity but equal P2P data contributions.

No limitation is placed on the invention concerning the mechanism used to assign a class to a terminal in the P2P network. A centralized assignment of this transmission capacity may be used.

In one embodiment of the invention, this assignment of a class to a terminal is protected from any subsequent uncontrolled modification. It is important that a user of a terminal not be allowed to modify the class associated with it so that it can pass itself off as a terminal with limited transmission capacity when such is not the case. To achieve this, a class can be assigned to a terminal automatically with no user intervention and without the user then being able to modify the assigned class. Thus a P2P application can be provided which handles the determination of a transmission capacity itself, for example by analyzing the type of terminal and/or the type of underlying physical network it uses to communicate.

It is also possible to have the remote peer receiving a request for digital content containing a class indication be able to determine if the class indicated by the terminal issuing the request is consistent with the issuing terminal. For this purpose, the issuing terminal is able to evaluate the transmission capacity of the terminal issuing the request.

In one embodiment, there is a central server in the network that is in charge of verifying the transmission capacities announced by a terminal in the network, on the basis of the type of terminal and/or the access network on which this terminal has declared itself.

The invention may advantageously be applied to a P2P network with transmission disparities, meaning that there are disparities in the transmission capacities of the terminals which may intercommunicate. The term “network with disparities” is understood to mean a network in which the terminals do not have the same transmission capacity, whether this difference in capacity is related to the type of the underlying physical networks to which the terminals belong or is specific to the terminal itself.

Thus, in one embodiment of the invention, the terminals of the peer-to-peer network belong to underlying physical networks of different types and the transmission capacity of a terminal at least corresponds to a network type. This type of P2P network is a heterogeneous network in which the terminals have different transmission bandwidth constraints depending on which physical network they belong to.

In this case, an ingenious application of the invention allows establishing a P2P network based on multiple physical networks of different types, which can limit the transmission capacity of their respective terminals to different values. Such is the case when a P2P network is constructed on a low bandwidth mobile network, a low bandwidth Internet, a 3G mobile network, an ADSL (Asymmetric Digital Subscriber Line) network, a 4G mobile network, a cable network, an ADSL 2 network, and/or a FTTH (Fiber To The Home) network. In this case, it is possible to define a class per type of network, each of these classes representing a distinct value for the transmission capacity. The respective terminals of these different types of networks are constrained to limited throughputs in their transmissions, by the physical networks to which they belong.

In one embodiment of the invention, the transmission capacity of a terminal at least corresponds to a transmission capacity specific to the terminal concerned. Thus the transmission capacities of the requesting terminal itself are advantageously taken into account in deciding whether to accept or refuse its request for digital content. It is then advantageous to weight a low contribution to the P2P network of a requesting terminal which does not have the ability to send a large amount of data, when a peer terminal is deciding whether to accept its request.

It is also possible to combine the above two embodiments by taking into account not only the bandwidth constraints imposed by the physical network to which the terminal belongs, but also the constraints specific to the terminal.

In one embodiment of the invention, the first terminal additionally stores data quantity values associated with the second terminals, said data quantity values respectively corresponding to the amounts of data already provided by the second terminals relative to digital content; and in step /2/, the first terminal additionally takes into account the stored data quantity value associated with the second terminal.

Here, it is advantageous to apply the invention to the P2P communication protocol initially based on considering the past level of contribution of a terminal when deciding whether to accept its request for digital content. In this embodiment, each terminal remembers the exchanges that have taken place over time with the other terminals in the P2P network concerned. This means storing a data quantity value for the digital content already provided in association with each of the terminals from which it has already received some or all of the digital content.

Because of these arrangements, it is possible to apply mechanisms equivalent to known mechanisms when deciding whether to accept a request for digital content within the same class, and set up a weighting system between different classes.

In particular, a table of terminals per class can be managed, with each class defined according to an embodiment of the invention. In this context, it is easy to apply mechanisms similar to those applied in the prior art within a group of terminals having the same class.

In addition, it is advantageous in step /2/ for the first terminal also to take into account a maximum upload bandwidth.

Certain P2P communication networks not only allow direct communication between terminals but also include a server. This server may handle identifying the location or locations of digital content available in the P2P network concerned. Such a server may correspond to a tracker in the context of a BitTorrent P2P protocol. A tracker receives a request for digital content from a terminal and selects a list of peer terminals which are likely to be able to provide the requested digital content. A mechanism of the invention can advantageously be applied in this type of P2P network with a server.

A second aspect of the invention therefore proposes a communication method between terminals in a peer-to-peer communication network comprising a server;

wherein classes are respectively assigned to said terminals, each class indicating the transmission capacity of a terminal;
said communication method comprising the following steps at the server:
/a/ receiving a request to transmit digital content to a terminal, said request indicating the class assigned to said terminal;
/b/ selecting, on the basis of the indicated class, a list of terminals able to transmit at least a portion of the digital content to the terminal; and
/c/ providing the terminal with said list of terminals.

More specifically, the transmission capacity of a terminal corresponds to at least one transmission characteristic associated with the terminal and depends at least on a type of underlying physical network to which the terminal belongs.

In this case, the server may advantageously take into account the transmission capacity of the terminal issuing the request, in order to select, from among the terminals of the P2P network which have the requested digital content, those which are most likely to accept the request from the terminal considering its assigned class.

A third aspect of the invention proposes a terminal which comprises a means for implementing a communication method according to the first aspect of the invention.

A fourth aspect of the invention proposes a server which comprises a means for implementing a communication method according to the second aspect of the invention.

A fifth aspect of the invention proposes a system comprising terminals according to the third aspect of the invention. It may also comprise a server according to the fourth aspect of the invention.

A sixth aspect of the invention proposes a computer program comprising instructions for implementing a method according to the first aspect of the invention, when this program is executed by a processor.

A seventh aspect of the invention proposes a storage medium on which the computer program according to the sixth aspect of the invention is stored.

An eighth aspect of the invention proposes a request signal for requesting the transmission of digital content to a terminal in a peer-to-peer communication network between terminals according to the third aspect of the invention, classes being respectively assigned to said terminals, each class indicating the transmission capacity of a terminal;

said request signal indicating the class assigned to the terminal that is to receive the content.

Other features and advantages of the invention will be apparent from the following detailed description, which refers to the attached drawings in which:

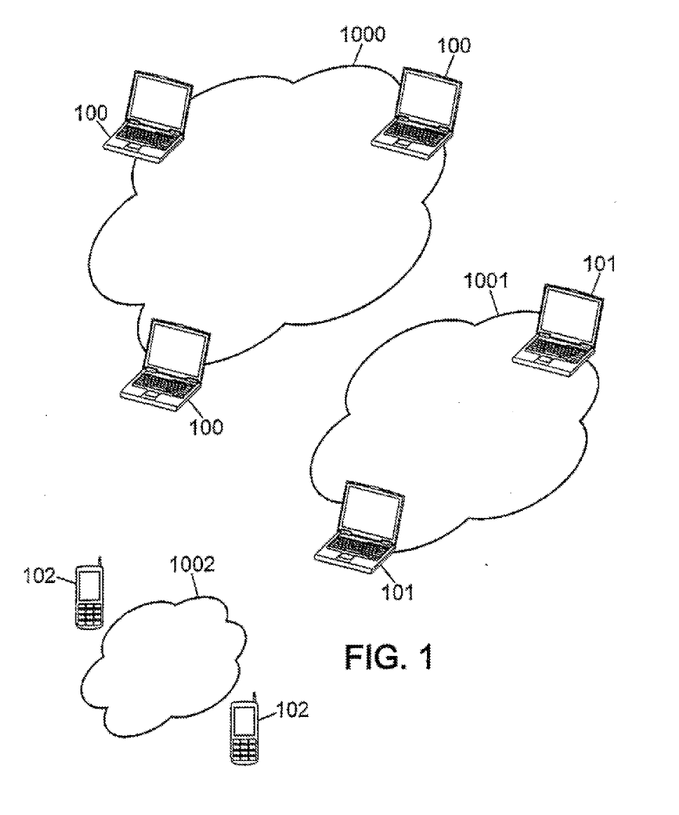

FIG. 1 illustrates a peer-to-peer communication network adapted to implement an embodiment of the invention;

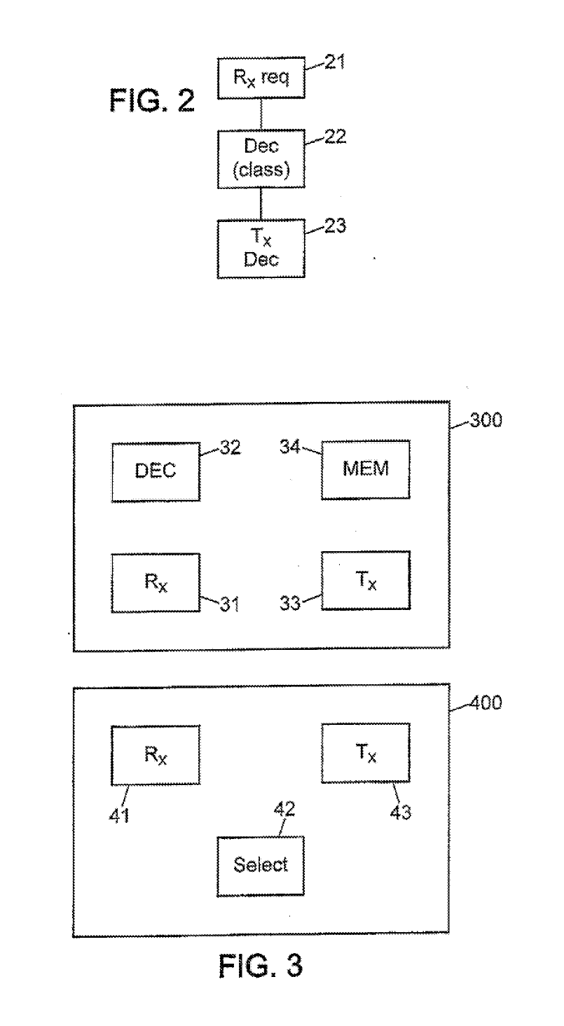

FIG. 2 illustrates the main steps of a communication method according to an embodiment of the invention; and

FIG. 3 illustrates a terminal and a server according to embodiments of the invention.

The same references are used in the different figures to denote identical or similar objects.

The invention has relevant applications in any type of network. Below, without limiting the possible applications of the invention, it is described as it applies to a heterogeneous P2P network based on multiple physical networks having disparities in the transmission limitations imposed on the terminals that belong to them. Of course, the invention advantageously applies equally well to a homogeneous P2P network using physical transmission resources of the same type, particularly for “erasing” to a certain extent the disparities between the transmission capacities of each of the terminals.

FIG. 1 illustrates a peer-to-peer communication network adapted to implement an embodiment of the invention. In this example, the P2P network concerned is based on three distinct types of physical networks.

The terms “physical network” or “underlying physical network” are understood to mean a communication network which offers physical transmission resources for communication in an application layer. A P2P communication is a communication application layer. The P2P network considered here is based on a FTTH network 1000 comprising terminals 100 that are computers, an ADSL network 1001 comprising terminals 101 that are computers, and a 3G mobile network 1002 comprising terminals 102 that are cell phones. The different underlying physical networks considered here do not impose the same constraints on the transmission rates.

The invention is described below as it applies to a P2P network of this type, meaning it is based on these three distinct types of physical networks.

FIG. 2 illustrates the main steps of a communication method according to an embodiment of the invention. Different respective classes are assigned to the terminals of the different physical networks. Recall that a class of the invention indicates a transmission capacity of a terminal. It can be arranged so that the same class is assigned to all terminals in the same physical network. Or different classes may be assigned to terminals in the same physical network in order to take into consideration the capacities of the terminals themselves, in addition to the throughput constraints of the physical network. The transmission capacity of a terminal thus corresponds to at least one transmission characteristic associated with the terminal.

In a first terminal, in step 21, a request is received to transmit digital content to a second terminal, with the request indicating the class assigned to the second terminal. This is, for example, a request for digital content originating from the second terminal.

Next, in step 22, the decision is made whether to transmit at least a portion of the digital content to the second terminal, on the basis of said indicated class. Then, in step 23, the decision is sent to the second terminal.

The first terminal and the second terminal may belong to physical networks of different types. For example, the first terminal may correspond to a terminal 100 that is a computer in the FTTH network 1000 and the second terminal may correspond to a terminal 102 that is a cell phone in the mobile network 1002. In one embodiment, a different class is defined for at least each type of network, reflecting the access limitations related to the underlying physical network. For example, the class associated with a terminal accessing via the FTTH network indicates a transmission capacity greater than that indicated by the class associated with a terminal accessing via the mobile network. A cell phone is generally subject to transmission constraints related to its mobile network. These constraints can result in a terminal 102 generally transmitting less than a terminal 100 in the P2P network, not because it does not want to contribute more to the P2P network but because it does not have the same bandwidth constraints as a terminal 100. Advantageously, the invention can be applied under such conditions to allow a terminal 102 still to receive digital content in the P2P network even when its contribution to transmissions in the P2P network is not significant.

For this purpose, in one embodiment of the invention, the second terminal therefore indicates its class in its digital content request message.

Then the first terminal 100 can decide, based on certain parameters, whether or not to act on the request from the second terminal. It takes into consideration the class indicated in the request. It may also take into consideration the amount of digital content data already received from this second terminal. In fact, in one embodiment, the class allows weighting the amount of digital content data already received from this terminal such that it does not penalize terminals which have transmitted very little due to the simple fact that they are unable to transmit more, because of their own capacities or limitations related to their mode of access.

For illustrative purposes only, the invention is described as it applies to a BitTorrent type of P2P communication protocol. From these sections, one can easily deduce an application to other P2P communication protocols.

In fact, one can easily implement the invention in the context of any other P2P communication protocol, such as a Peering Portal or RayV protocol for example. It is sufficient to introduce into a digital content request message the indication of the class to which the terminal issuing the request belongs. In addition, a decision logic for deciding whether to accept or refuse the transmission of the requested digital content according to an embodiment of the invention must be applied at the terminals of the P2P network concerned.

In an existing P2P communication protocol, one can easily define a new field or reuse an existing or reserved field to allow a peer to indicate a class which characterizes it according to an embodiment of the invention. Then, the algorithms already in use in the terminals of the P2P network for deciding whether to accept the transmission of digital content, can be modified to take into account the class of a peer terminal.

The BitTorrent protocol is adapted for P2P file transmission, but the invention can easily be implemented within a P2P protocol which transmits digital content such as video or any other type.

In the context of the BitTorrent protocol, for example, a terminal referred to as the client peer terminal, as it wants to receive certain digital content, maintains information and keeps it up to date concerning its state for each connection it establishes with a remote peer terminal referred to as the server peer terminal. This state can be:

“Choked”: when no request from the client peer terminal can be satisfied; or

“Interested”: when the server peer terminal is interested in digital content that the client peer terminal can offer it. This notification signifies that the server peer terminal will begin to send requests for all or part of the digital content when the client peer terminal puts it in the “Unchoked” state.

The client peer terminal also needs to know whether it is “Interested” in the server peer terminal, and if the server peer terminal is in the choked or unchoked state for it. The list of states of the client peer terminal is as follows:
am_choking: the client peer terminal has choked the server peer terminal;
am_interested: the client peer terminal is interested in the server peer terminal;
peer_choking: the server peer terminal has choked the client peer terminal;
peer_interested: the sever peer terminal is interested in the client peer terminal.

In general, a connection with a new terminal starts out in the “choked” and “not interested” state.

At least a portion of the digital content (or file block here) can be sent to the client peer terminal if the client peer terminal is interested in a server peer terminal, and this server peer terminal is not choking.

More specifically, the communication protocol between peer terminals provides for the transmission of a first message, referred to as a handshake, by the client peer terminal. In an embodiment of the invention, this message indicates the following fields:
pstrlen: Length of <pstr>
pstr: protocol identifier
class_id: identifier for the class to which the client peer terminal belongs;
info_hash: information concerning the application of a hash function to a key;
peer_id: unique identifier for the client peer terminal.

In general, it is also arranged in this BitTorrent protocol such that the past exchanges between peer terminals are stored in memory and the data quantity values relative to these past transactions are taken into account when deciding whether to accept or refuse the transmission of data to peer terminals.

In one embodiment of the invention in its application to the BitTorrent protocol, each peer terminal may maintain updated lists of peer terminals ordered according to their classes. It is then easy to have an acceptance algorithm which bases the acceptance decision on both the class and the past transactions with a terminal.

It is advantageous to manage a list or a table of terminals per class, i.e. grouping the terminals by their class, then applying, within a group of terminals of the same class, a mechanism similar to one of those previously used in the prior art. This decision algorithm may advantageously be adapted to each application implemented according to this P2P communication protocol.

In one embodiment, a terminal may thus authorize a certain number of client terminals to communicate with it as a function of the bandwidth it can offer. For example, a terminal has an upload bandwidth of 20 Mbps in a given underlying physical network. It can therefore be arranged so that this terminal accepts the requests received as long as the sum of the receiving bandwidths of the terminals issuing the request is less than this upload bandwidth. Thus, when it receives requests from client terminals in an ADSL network (the type of network corresponding to the class indicated in the digital content request), it may decide to agree by offering 2 Mbps connections. When these requests originate from terminals in a Wifi network, it may agree and offer 512 kbps connections. When these requests originate from terminals in a UMTS network, it may agree and offer 200 kbps connections. At each acceptance decision, the terminal concerned may advantageously verify the sum of the bandwidths for the connections already accepted versus the value of its upload bandwidth.

In another specific embodiment, the peer-to-peer communication network comprises a server, arranged to identify the location or locations of digital content available in the P2P communication network concerned and to provide at a terminal's request a list of terminals able to provide at least a portion of the desired content. In its application to the BitTorrent protocol, this is the tracker server, for example.

The server receives a request to transmit digital content to a terminal, said request indicating the class assigned to the terminal, and selects on the basis of the indicated class a list of terminals able to transmit at least a portion of the digital content to the terminal, then provides the requesting terminal with said list of terminals.

This other embodiment of the invention allows selecting terminals able to provide at least a portion of the content as a function of the class assigned to the requesting terminal, thus lightening the load at the client terminal. In addition, such a server can be the basis for implementing a verification of the class indicated in the request emitted by the client terminal in order to prevent possible fraud in the assignment of this class. The server is then able to evaluate the transmission capacity specific to the client terminal and/or its transmission capacity as related to the underlying physical network it is connected to.

FIG. 3 illustrates a terminal and a server according to an embodiment of the invention.

The terminal comprises:
a receiving unit 31 for receiving a request to transmit digital content to another terminal, with the request indicating the class assigned to this other terminal;
a decision unit 32 for deciding on the basis of said indicated class whether or not to transmit to said terminal at least a portion of said digital content; and
a transmission unit 33 for transmitting the decision to the other terminal.

The terminal may additionally comprise a memory 34 for storing data quantity values associated with the other terminals, the data quantity values respectively corresponding to the amount of data already provided by the other terminals relative to digital content, and the decision unit may additionally be able to take into account the stored data quantity value associated with the other terminal.

A server 400 according to an embodiment comprises
a receiving unit 41 for receiving a request to transmit digital content to a terminal, said request indicating the class assigned to said terminal;
a selection unit 42 for selecting, on the basis of the indicated class, a list of terminals able to transmit at least a portion of the digital content to the terminal; and
a transmission unit 43 for providing the terminal with said list of terminals.

1. A communication method between terminals of a peer-to-peer communication network;
wherein classes are respectively assigned to said terminals, each class indicating the transmission capacity of a terminal, said transmission capacity of a terminal corresponding to at least one transmission characteristic associated with the terminal and dependent at least on a type of underlying physical network to which the terminal belongs;
said method comprising the following steps in a first terminal:
/1/ receiving a request to transmit digital content to a second terminal, said request indicating the class assigned to the second terminal;
/2/ deciding whether or not to transmit at least a portion of said digital content to said second terminal on the basis of said indicated class; and
/3/ transmitting the decision to the second terminal.

2. The communication method according to claim 1, wherein the terminals of the peer-to-peer communication network belong to underlying physical networks of respective different types.

3. The communication method according to claim 1, wherein the transmission capacity of a terminal additionally depends on a transmission capacity specific to said terminal.

4. The communication method according to claim 1, wherein the first terminal additionally stores data quantity values associated with the second terminals, said data quantity values respectively corresponding to the amounts of data already provided by the second terminals relative to digital content; and
wherein, in step /2/, the first terminal additionally takes into account the stored data quantity value associated with the second terminal.

5. The communication method according to claim 1, wherein, in step /2/, the first terminal additionally takes into account a maximum upload bandwidth value.

6. A communication method between terminals in a peer-to-peer communication network comprising a server;
wherein classes are respectively assigned to said terminals, each class indicating a transmission capacity of a terminal, the transmission capacity of a terminal corresponding to at least one transmission characteristic associated with the terminal and dependent at least on a type of underlying physical network to which the terminal belongs;
said communication method comprising the following steps at the server:
/a/ receiving a request to transmit digital content to a terminal, said request indicating the class assigned to said terminal;
/b/ selecting, on the basis of the indicated class, a list of terminals able to transmit at least a portion of the digital content to the terminal; and
/c/ providing the terminal with said list of terminals.

7. A terminal in a peer-to-peer communication network comprising a plurality of terminals;
classes are respectively assigned to said terminals, each class indicating the transmission capacity of a terminal, the transmission capacity of a terminal corresponding to at least one transmission characteristic associated with the terminal and dependent at least on a type of underlying physical network to which the terminal belongs;
said terminal comprising:
a receiving unit for receiving a request to transmit digital content to another terminal, said request indicating the class assigned to said other terminal;
a decision unit for deciding on the basis of said indicated class whether or not to transmit to said other terminal at least a portion of said digital content; and
a transmission unit for transmitting the decision to said other terminal.

8. The terminal according to claim 7, wherein the transmission capacity additionally depends on a transmission capacity specific to said terminal.

9. l The terminal according to claim 7, additionally comprising a memory for additionally storing data quantity values associated with the other terminals, said data quantity values respectively corresponding to the amounts of data already provided by the other terminals relative to digital content; and
wherein the decision unit is also able to take into account the stored data quantity value associated with the other terminal.

10. A server in which classes are respectively assigned to terminals of a peer-to-peer communication network, each class indicating the transmission capacity of a terminal, the transmission capacity of a terminal corresponding to at least one transmission characteristic associated with the terminal and dependent at least on a type of underlying physical network to which the terminal belongs;
said server comprising:
a receiving unit for receiving a request to transmit digital content to a terminal, said request indicating the class assigned to said terminal;
a selection unit for selecting, on the basis of the indicated class, a list of terminals able to transmit at least a portion of the digital content to the terminal; and
a transmission unit for providing the terminal with said list of terminals.

11. A peer-to-peer communication system comprising;
terminals according to claim 7; and
a server in which classes are respectively assigned to terminals of a peer-to-peer communication network, each class indicating the transmission capacity of a terminal, the transmission capacity of a terminal corresponding to at least one transmission characteristic associated with the terminal and dependent at least on a type of underlying physical network to which the terminal belongs;
said server comprising:
a receiving unit for receiving a request to transmit digital content to a terminal, said request indicating the class assigned to said terminal;
a selection unit for selecting, on the basis of the indicated class, a list of terminals able to transmit at least a portion of the digital content to the terminal; and
a transmission unit for providing the terminal with said list of terminals.

12. A non-transitory computer program product comprising instructions for implementing the method according to claim 1, when this program is executed by a processor.

13. (canceled)

14. A method for preparing a request signal for requesting the transmission of digital content to a terminal in a peer-to-peer communication network between terminals, comprising:
respectively assigning classes to said terminals, each class indicating the transmission capacity of a terminal;
associating the transmission capacity corresponding to at least one transmission characteristic with the terminal and which is dependent on at least a type of underlying physical network to which the terminal belongs;
wherein said request signal indicates the class assigned to the terminal that is to receive the digital content.
